(19) United States
(12) Patent Application Publication
(10) Pub. No.: US 2015/0308916 A1
(43) Pub. Date: Oct. 29, 2015

(54) Leak Detector

(71) Applicant: INFICON GMBH, Koeln (DE)

(72) Inventor: Ralf Nelles, Kerpen (DE)

(21) Appl. No.: 14/441,236

(22) PCT Filed: Nov. 8, 2013
(86) PCT No.: PCT/EP2013/073396

§ 371 Date: May 7, 2015

(30) Foreign Application Priority Data
Nov. 9, 2012 (DE) 10 2012 220 483.0

(51) Int. Cl. G01M 3/04

(52) U.S. Cl. CPC G01M 3/042

(57) ABSTRACT

A leak detector including a test chamber for accommodating a test object and a test gas sensor connected to the test chamber for detecting test gas escaping from the test object. The test gas sensor is arranged together with the gas-carrying components in a container through which fresh air flows, wherein any test gas penetrating the container is carried off into the surroundings.

The invention relates to a leak detector comprising a test chamber for accommodating a test object and a test gas sensor connected to the test chamber via gas-carrying components for detecting test gas escaping from the test object.

Leak detectors operate such that a detectable test gas is used in order to determine whether a test object, for example a container or a line, is gas-tight. Mass spectrometers that are capable of detecting various gasses are often used as test gas sensors. Mass spectrometers require a high vacuum, however, in order to operate. Mass spectrometers therefore require a highly complex vacuum pump device. As an alternative to the use of a mass spectrometer, a gas-selective test gas sensor can be used, which, in particular, reacts only to the test gas and measures the partial pressure of the test gas. One example of such a test gas sensor is the wise sensor. This contains a heated quartz window, which is permeable only to helium or hydrogen as the test gas. A pressure measuring device, in particular a cold-cathode device, is located in a closed hollow space penetrated by the test gas through the quartz window. Since no gasses other than the test gas (helium) enter the hollow space, the measurement signal of the pressure sensor is an indication of the helium concentration at the sensor surface.

A problem that occurs with test gas sensors is that the sensor becomes contaminated by being acted upon to an excessive extent with the gas to be detected (test gas). As the contamination increases, the sensor becomes insensitive to the test gas such that meaningful results are not obtained.

Clouds of test gas, which float in space and cannot be identified by odor, are occasionally present in an environment in which leak detection tests are carried out. In an industrial environment enriched with test gas, the test gas sensor would be adversely affected via unavoidable leaks and permeation at valves and hose connections of the leak detector such that accurate measurements would no longer be possible.

Document DE 10 2010 007 417 A1 (Inficon GmbH) describes a leak detector, which comprises—outside of the test gas sensor—a reservoir filled with a non-contaminated flushing gas, which is connected to the test gas sensor when the test gas concentration at the test gas sensor exceeds a threshold value in a standby mode. As a result, it is possible to achieve only a temporary flushing of the test gas sensor, but not reliable, non-stop operation of the test gas sensor.

The problem addressed by the invention is that of creating a test gas sensor, which can also be used reliably in contaminated surroundings.

According to the invention, the test gas sensor is arranged together with the gas-carrying components in a container through which pressurized fresh air flows, wherein any test gas penetrating the container is carried off into the surroundings.

An overpressure is generated in the container, in a manner similar to that utilized in a clean room, which prevents ambient air from penetrating the container. The container should always be sealed with respect to the surroundings, although high requirements are not placed on the quality of the seal. The seal is used primarily to maintain an overpressure of the fresh air in the interior of the container such that external atmospheric influences do not act on the interior of the container. Fresh air is intended to mean outside air, which is suctioned in at a distance from the test chamber and the container. The test chamber and the container are usually arranged in a factory building, the air of which can be contaminated with the test gas (helium) without this being noticed. The fresh air is therefore not suctioned in in the same building, but rather as outside air from the outside.

The gas-carrying components can be valves, hoses, filters, and similar parts. Leaks can occur in such components. It must be taken into account that helium, which is often used as a test gas, is a very “thin” gas, which penetrates the smallest gaps. The test gas escaping from the test gas sensor and the gas-carrying components is carried off by means of the permanent flushing of the container with fresh air such that a fresh-air atmosphere is permanently maintained in the container.

A wise sensor or a quartz window sensor as described in EP 1295117 B1 is preferably used as the test gas sensor. Such a sensor contains a selective diaphragm, which is permeable to a certain test gas and contains a pressure sensor behind the diaphragm. One advantage is that a high vacuum is not required, as is the case with a mass spectrometer.

According to a preferred embodiment of the invention, a reference line for feeding gas to the test gas sensor has an inlet arranged in the container. In this case, the reference line, via which uncontaminated gas is suctioned in, does not need to be routed out of the container.

The test gas sensor requires a pump for carrying off gas after said gas passes through the test gas sensor. Expediently, this pump is arranged outside of the container. It is advantageous that the pump can be replaced without intervention into the container and that the user can freely select the pump.

The container, through which fresh air flows, contains a fresh air inlet and an air outlet. A throttle element is preferably provided at the air outlet, in order to maintain an overpressure, with respect to the surroundings, in the container.

An exemplary embodiment of the invention is explained in greater detail in the following with reference to the sole figure of the drawing.

In the drawing:

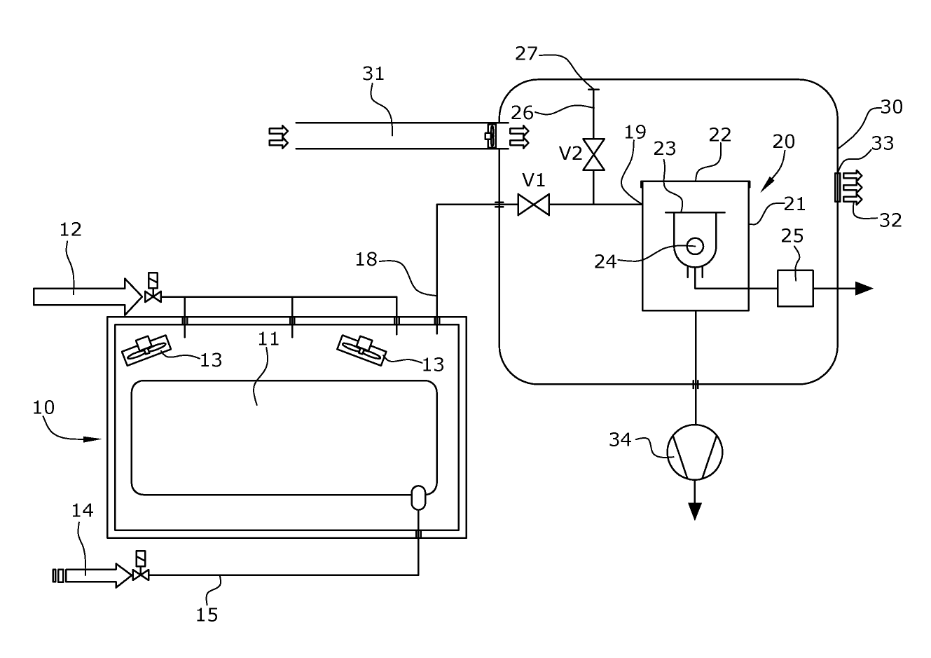

FIG. 1 shows a schematic depiction of a leak detector according to the present invention.

The leak detector comprises a test chamber 10 for accommodating a test object 11. The test object 11 is a hollow body filled with the test gas (helium). The test chamber 10 is sealed to the outside. It is connected to a compressed-air source 12 in order to temporarily introduce compressed air into the test chamber for flushing. After flushing, atmospheric pressure prevails in the test chamber. Ventilators 13 for circulating and mixing the gas located in the test chamber are located in the test chamber. In the testing process, the test object 11 is connected to a test gas source 14 via a line 15 such that an overpressure with respect to the surroundings of the test object is generated in the interior of the test object.

A measurement gas line 18, which contains a controllable valve V1, extends out of the test chamber 10 to a coupling 19 of the test gas sensor 20. This test gas sensor comprises a sensor housing 21, which is tightly connected to a removable cover 22. A selective diaphragm 23, which is permeable to the test gas and delimits a hollow space located behind said diaphragm, is located in the sensor housing. A pressure measuring device 24, e.g., a cold-cathode device, is located in this hollow space. Gas, which enters the sensor housing 21 via the measurement line 18, is checked behind the diaphragm 23 for the presence of test gas and a corresponding measurement value generated by the pressure measuring device 24 is fed to electronics 25, the output signal of which indicates the test gas concentration.

The entire test gas sensor 20, including the associated gas-carrying components, such as valves, filters, wall feedthroughs, and the like, is arranged in a closed container 30. This container has a fresh air inlet 31, to which pressurized fresh air is fed. Fresh air is not intended to mean the ambient air, which can be contaminated with test gas, but rather fresh air fed from the outside. An air outlet 32, which contains a throttle device 33, is located on the wall opposite the fresh air inlet 31. The throttle device 33 has the effect that a pressure that is higher than the ambient pressure is always maintained in the interior of the container 30.

The sensor housing 21 is connected to a suction pump 34, which draws the gas to be tested through the sensor housing 21 and, therefore, along the diaphragm 23. The pump 34 is arranged outside of the container 30 and can therefore be freely selected or replaced without intervention into the container 30.

In addition to the measurement line 18, a reference line 26 containing a valve V2 is connected at the inlet 19. The inlet 27 of the reference line 26 is located in the interior of the container 30. This ensures that the reference line is always supplied with fresh air. The reference line is used to monitor the underlying surface of the test gas sensor. It also makes it possible for the sensor to be permanently flushed given an open valve V2 and a closed valve V1 of the measurement line 18.

The valves V1 and V2 are actuated in alternation. In one measurement procedure, the valve V1 is open and the valve V2 is closed. The valves are controlled by a (non-illustrated) control device, in a manner similar to that described in DE 10 2010 007 417 A1.

Although the container 30 must be tight, in general, relatively high requirements are not placed on the quality of the seal. The overpressure with respect to the surroundings ensures that gas from the surroundings cannot penetrate the container.

The leak detector functions with non-stop operation. Contaminations of the ambiment air with test gas cannot adulterate the measurement.

1. A leak detector comprising a test chamber for accommodating a test object and a test gas sensor connected to the test chamber via gas-carrying components for detecting test gas escaping from the test object,
wherein the test gas sensor is arranged together with the gas-carrying components in a container through which pressurized fresh air flows, and any test gas penetrating the container is carried off into the surroundings.

2. The leak detector according to claim 1, wherein a reference line for feeding gas to the test gas sensor comprises an inlet arranged in the container.

3. The leak detector according to claim 1, wherein a pump for carrying off gas after said gas passes through the test gas sensor is arranged outside of the container.

4. The leak detector according to claim 1, wherein the container comprises a fresh air inlet and an air outlet, wherein a throttle element is provided at the air outlet in order to maintain an overpressure, with respect to the surroundings, in the container.
